(19) United States
(12) Patent Application Publication
(10) Pub. No.: US 2002/0019600 A1
(43) Pub. Date: Feb. 14, 2002

(54) Oscillating massage table

(76) Inventor: Joseph E. Hwang, Bayside, NY (US)

Correspondence Address: COLLARD & ROE, P.C., 1077 Northern Boulevard, Roslyn, NY, 11576, US

(21) Appl. No.: 09/981,492

(22) Filed: Oct. 16, 2001

Related U.S. Application Data
(63) Continuation-in-part of application No. 09/634,311, filed on Aug. 8, 2000.

(51) Int. Cl. A61H 15/00

(52) U.S. Cl. 601/122

(57) ABSTRACT

A massage table for massaging a user. This massage table contains a base which holds a motor. This base has a plurality of rails which support a series of rollers. A table top rides on these rollers and is connected to the motor via a piston. This motor drives the table top back and forth on top of these rollers. The table top can contain a plurality of heaters that are covered by a cover. The cover can be formed with ribs or bumps so as to improve the massaging sensation experienced by the user.

### CROSS REFERENCE TO RELATED APPLICATIONS

This application is a continuation in part application of U.S. patent application Ser. No. 09/634,311 filed on Aug. 8, 2001, which is incorporated by reference, and wherein this application claims priority under 35 U.S.C. §120.

### BACKGROUND OF THE INVENTION

1. Field of the Invention

The invention relates to an oscillating massage table that is driven by a motor disposed below a table. The table can also contain a series of heating elements disposed below a cloth or soft covering.

### SUMMARY OF THE INVENTION

The invention relates to a table based massager that oscillates back and forth to generate a massaging sensation for a user. The table consists of a base that contains four legs and a stand. There is a motor that is coupled to this base wherein this motor drives a piston back and forth. Coupled to this piston is a table top which may contain a plurality of heaters. There is also a cover that can be made of cloth or a leather type material that covers this plurality of heaters. The table top slides back and forth on top of the base. This table top rests on a series of rollers in the base wherein these rollers allow the table top to move rapidly over the base to create an oscillating motion.

The cover can also be padded or contain a stiff type material so that this cover contains a plurality of ribs or bumps on a top surface of the cover. With this ribbed or bumps, the cover which oscillates back and forth creates a massaging sensation for the user.

### BRIEF DESCRIPTION OF THE DRAWINGS

Other objects and features of the present invention will become apparent from the following detailed description considered in connection with the accompanying drawings which disclose three embodiments of the present invention. It should be understood, however, that the drawings are designed for the purpose of illustration only and not as a definition of the limits of the invention.

In the drawings wherein similar reference characters denote similar elements throughout the several views:

FIG. 1 is an exploded perspective view of the device according to the invention;

FIG. 2A is a side cross sectional view of the invention;

FIG. 2B is a side cross-sectional view of a second embodiment of the invention;

FIG. 3 is a perspective view of the invention without the cover; and

FIG. 4 is a perspective view of another embodiment of the invention without the cover.

### DETAILED DESCRIPTION OF THE PREFERRED EMBODIMENT

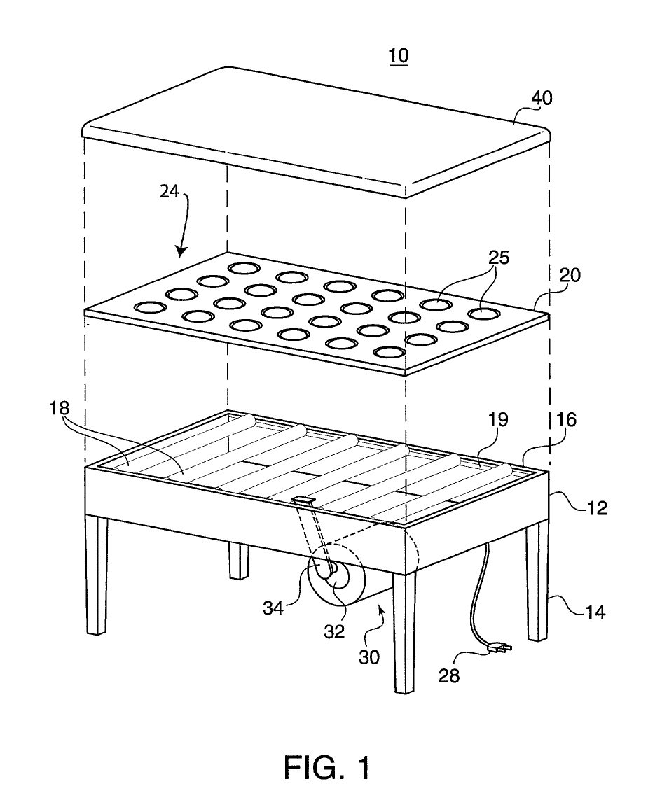

Referring in detail to the drawings, FIG. 1 shows an exploded perspective view of the device 10 wherein there is shown a base table 12 which has a plurality of legs 14. Base table 12 also contains a table rim 16 which houses a plurality of rollers 18. Rim 16 is essentially a hollowed out plane wherein rollers 18 rest inside of this hollowed out plane, on rails 19 and allow a table top 20 to ride on top. Rollers 18 are essentially fixed wheels that are coupled to rails 19 via an axle.

Table top 20 is planar, and contains a plurality of heaters 24 which may be in the form of heat lamps 25 or a heating coil 26. These heaters are driven by an electric current. A plug 28 extends out from table top 20 so that table top 20 can be plugged into a wall.

There is also a reciprocating motor 30 having a motor housing 32 which drives table top 20 back and forth on top of rollers 18 in rim 16. A piston 34 extends out from motor 30 wherein piston 34 is coupled at one end to motor 30 and an opposite end to table top 20.

As piston 34 is driven, it extends in and out from motor housing 32 so that this piston drives table top 20 back and forth in a rapid manner. On top of table top 20 is a cover 40 which covers table top 20 so that heaters 24 do not come in direct contact with a user lying on top of the table top.

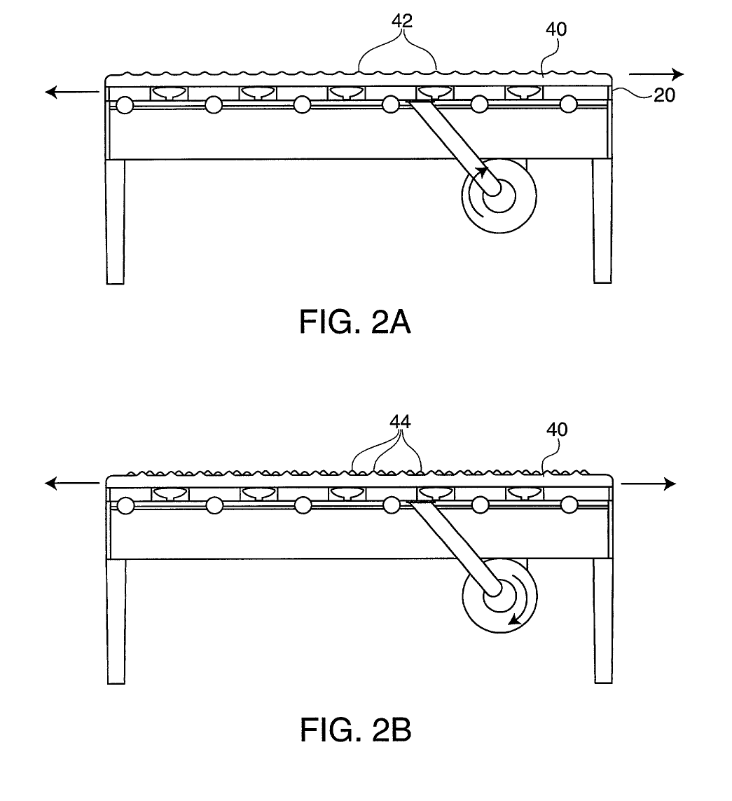

FIG. 2A shows a cross sectional view of the device wherein cover 40 is designed with a plurality of ribs 42 so that the user will roll across these ribs as table top 20 oscillates back and forth. The friction generated between the user's body and this cover creates a massaging sensation massaging the users' muscles.

FIG. 2B shows a cross-sectional view of the second embodiment of cover 40 which has a plurality of bumps 44 disposed within the cover. These bumps extend up, supporting a multi-contoured surface in the cover.

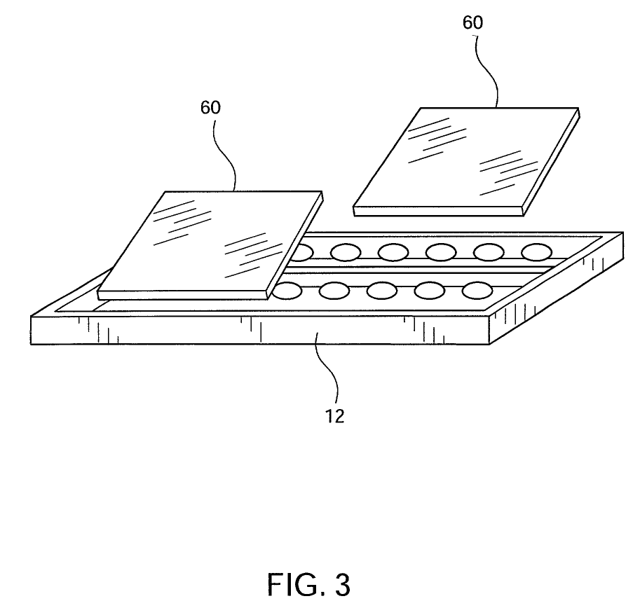

FIG. 3 shows a perspective view of the device 10 with cover 40 removed. Instead a plurality of pads 60 are shown being removed from on top of this device 10. This perspective view shows a plurality of heating lamps 25 arranged in table top 20. These heating lamps 25 heat up when the table is in use so that the user receives beneficial heat from these heat lamps.

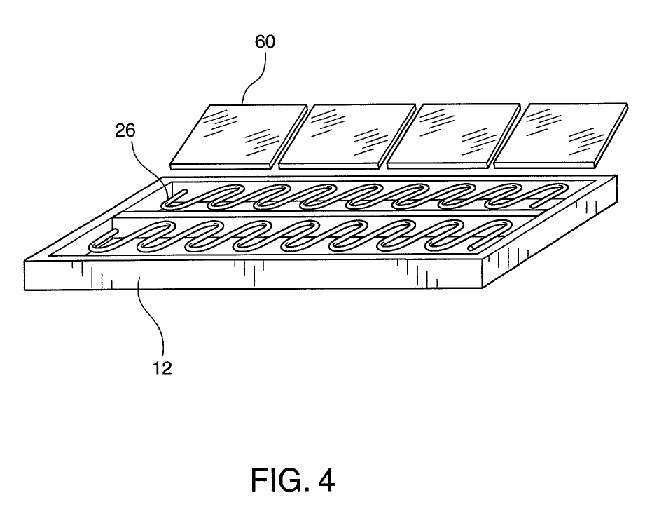

FIG. 4 shows a perspective view of device 10 with cover 40 removed and pads 60 placed above device 10. In this case, perspective view shows a heating coil 27 embedded in table top 20. Heating coil 27 is heated from an electric current passed through coil 27 so that the heat can emanate through cover 40 and up to the user. Thus, with this design as well, the user receives beneficial heat from the heating coil.

The oscillating motion of table top 20 back and forth generates a massaging sensation for a user. Generally massages are generated by a massage therapist pressing his or her hands on the user to generate friction and heat between the therapist's hands and the user. This friction is simulated by the rapid movement of table top 20 back and forth. In addition the heat normally generated by the massage therapist is created by heaters 24 in the form of heat lamps 25 or a heating coil 27.

Accordingly, while several embodiments of the present invention have been shown and described, it is to be understood that many changes and modifications may be made thereunto without departing from the spirit and scope of the invention as defined in the appended claims.

What is claimed is:

1. A massage table for a user comprising:
a) a table base comprising a plurality of legs and an upper rim forming a hollow plane;
b) a plurality of rollers coupled to said upper rim;
c) a plurality of axles for coupling said rollers to said upper rim;
d) a table top which is slidably mounted on top of said rollers;
e) a reciprocating motor disposed adjacent to said table base; and
f) a piston coupling said reciprocating motor to said table top, wherein when said reciprocating motor is in operation, said motor drives said piston back and forth which thereby drives said table top back and forth across said rollers creating a frictional force between said table top and the user.

2. The massage table as in claim 1, further comprising at least one heater disposed within said table top.

3. The massage table as in claim 2, wherein said at least one heater comprises a plurality of heating lamps disposed within said table top.

4. The massage table as in claim 2, wherein said at least one heater comprises at least one heating coil disposed within said table top.

5. The massage table as in claim 2, further comprising a cover for covering said heaters.

6. The massage table as in claim 5, wherein said cover further comprises a plurality of ribs disposed within said cover.

7. The massage table as in claim 5, wherein said cover further comprises a plurality of bumps disposed within said cover.

8. The massage table as in claim 1, wherein said motor is coupled to said table base.

9. A massage table for a user comprising:
a) a table base comprising a plurality of legs and an upper rim forming a hollow plane;
b) a plurality of rollers coupled to said upper rim;
c) a plurality of axles for fixing said rollers to said upper rim;
d) a table top which is slidably mounted on top of said rollers wherein said table top contains a rim so that said table top cannot slide off of said rollers;
e) a plurality of heaters disposed within said table top;
f) a cover for covering said plurality of heaters;
g) an electric reciprocating motor disposed adjacent to said table base;
h) a piston coupling said reciprocating motor to said table top, wherein when said reciprocating motor is in operation, said motor drives said piston back and forth which thereby drives said table top back and forth across said rollers creating a frictional force between said table top and the user.
